(19) United States
(12) Patent Application Publication
(10) Pub. No.: US 2007/0273679 A1
(43) Pub. Date: Nov. 29, 2007

(54) Orientation data collection system

(76) Inventor: Daniel Joseph Barton, New South Wales (AU)

Correspondence Address: BERGMAN & SONG, LLP, P.O. BOX 400198, CAMBRIDGE, MA, 02140, US

(21) Appl. No.: 10/591,819

(22) PCT Filed: Mar. 7, 2005
(86) PCT No.: PCT/AU05/00320

§ 371 Date: Sep. 6, 2006

(30) Foreign Application Priority Data
Mar. 8, 2004 (AU) 2004901181

(51) Int. Cl. G06F 3/03

(52) U.S. Cl. 345/207

(57) ABSTRACT

A data collection system includes a sensing device to receive a visible light signal, an optical characteristic recognition processing device to receive a signal from the sensing device, and an optical signal device adapted to generate, reflect or transmit the visible light signal onto the sensing device. The optical signal includes an optical characteristic that is perceived by the sensing device as varying as a function of a relative angle between the sensing device and the optical signal device. The optical characteristic recognition device is adapted to detect this variation and produce an output corresponding to a physical or other characteristic of the optical signal device. A gaming system, such as a computer based, console-based, arcade-based gaming system utilizes the data collection system to provide orientation data to a control system for the gaming system or to an identification mechanism for allowing access to the gaming system.

### FIELD OF THE INVENTION

The present invention relates to systems, methods and apparatus which gather and process data concerning the spatial orientation of an object and an identification system associated therewith.

### BACKGROUND OF THE INVENTION

The advent and proliferation of gaming technology in the past few years has led to a widening of the acceptance video/console gaming systems. Such systems have thus far had limited ability to collect spatial orientation data as game input, due to the high cost of manufacture of interfaces which are physically capable of collecting natural 3D movement input by viewers. By far the most common form of spatial direction input has been with a joystick attached to standard game controllers like those bundled with XBox® and Play Station 2® consoles.

One reason for this is that it is expected that the gathering of orientation data by known remote spatial sensing systems requires more processing power than is practically available in current and near future game consoles. Further, the alternative approach (purpose built devices for 3D spatial data collection) such as joy sticks, steering wheels etc are expensive, highly complex, game specific, and cannot be manufactured with appropriate robustness within the price range of the majority of the target market.

It is believed that if orientation data systems can be provided which are relatively simple, relatively inexpensive and robust, that such systems when programmed for interaction with gaming consoles, may give to users of such consoles a greater degree of enjoyment and interaction, than current systems.

The present invention seeks to provide a data collection system, method and apparatus, which will ameliorate, at least in part, at least one of the drawbacks of complex data orientation systems.

The present invention also seeks to provide an alternative solution.

The applicant does not concede that the prior art discussed in the specification forms part of the common general knowledge in the art at the priority date of this application.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention provides a data collection system having:
(a) at least one sensing means to detect and receive a visible light signal;
(b) an optical characteristic recognition processing means which receives signals from said at least one sensing means;
(c) at least one optical signal means associated with a respective one of said sensing means which generates, reflects or transmits visible light to said sensing means;
   wherein said optical signal means causes an optical characteristic to be visible to, or sensed by, said sensing means, said optical characteristic being caused to change when the relative angle between said sensing means and said at least one optical signal means is changed, whereby change in said optical characteristic is processed by said processing means to identify a physical or other characteristic of said at least one optical signal means.

The optical characteristic can be one or a combination of one or more of the following: a pattern; an indicia; a colour; a shape.

The physical or other characteristic of said at least one optical signal means can be a change in angle of orientation between said at least one optical signal means and said at least one sensing means.

The change in angle of orientation can be communicated to a CPU for use in processing to identify or quantify the change in angular orientation between said at least one sensing means and said at least one optical signal means.

The data collection system can be used as part of an identification system, with said at least one optical signal means acting as a key.

The at least one sensing means can be at a stationary reference point.

The at least one sensing means does not change its orientation relative to earth.

The at least one optical signal means can be positioned on an object the orientation of which is being sensed relative to said at least one sensing means' orientation.

The at least one optical signal means can be at a stationary reference point.

The at least one optical signal means does not change its orientation relative to earth.

The at least one sensing means can be positioned on an object the orientation of which is being sensed relative to said at least one optical signal means' orientation.

The at least one optical signal means can produce a visible signal by means of reflected and or transmitted light.

The at least one optical signal means can utilise one or a combination of more than one of the following: a holographic system, a lenticular system, a polarised filter system

The holographic system, the lenticular system or the polarised filter system each has one, or a sequence of more than one, image associated therewith.

The at least one optical signal means can be one or more lenticular systems.

More than one lenticular system can be utilised with respective lenticular images viewable in a respective one of said more than one lenticular system when viewed from different orientations.

Columnar lenticules can be utilised in said lenticular system.

Multiple lenticular systems can be used with the columnar direction of the lenticules of each respective lenticular system being at a different angle to each of the other lenticular systems.

The at least one optical signal means can be made up of a plurality of lenticular systems, with each lenticular system being located in substantially the same planar orientation.

The at least one optical signal means can be made up of a plurality of lenticular systems, with one or more lenticular system being located in a different planar orientation to the rest of the lenticular systems.

Two lenticular systems can be used with the angular spacing, between the columnar lenticules on one lenticular system relative to the other lenticular system, is 90°.

Three lenticular systems can be used with the angular spacing, between the columnar lenticules between respective lenticular systems, is 120°.

Four lenticular panels can be used with the angular spacing, between the columnar lenticules of a first and second lenticular system, being approximately 90°.

The angular spacing between a first set of first and second lenticular systems and a second set of first and second lenticular systems, can be approximately 45°.

The at least one optical signal means can be located within a distinctively shaped panel or border to form a target.

The at least one optical signal means can be such that when said at least one optical signal means is viewed from different angles, then an exhibited pattern will change to a different pattern; or an exhibited indicia will change to a different indicia; or a exhibited colour will change to a different colour, or an exhibited shape will change to a different shape.

The at least one optical signal means can be such that when said at least one optical signal means is viewed from different angles, then an exhibited pattern will change to one or more than one of: an indicia, colour or shape; or an exhibited indicia will change to one or more than one of: a pattern, colour, shape; or an exhibited colour will change to one or more than one of: a pattern, indicia, shape; or an exhibited shape will change to one or more than one of: a pattern, indicia, colour.

The indicia can include letters, numbers, symbols or any appropriate machine recognisable image.

The sensing means can be a digital camera or a digital video camera.

The can be only one sensing means and only one optical signal means.

The processing means can operate to identify the angular orientation by one or more of the following: comparing the light or images sensed from said optical signal means to a predefined table to determine orientation; processing by means of logical progression through an algorithm.

Means can be provided in said processing means, and said sensing means to calibrate a starting orientation of said optical signal means to said sensing means.

The multiple sensing means can be provided at different orientations to receive images from a generally stationary said at least one optical signal means.

The multiple sensing means can be provided at different orientations to receive images from said at least one optical signal means changing its orientation relative to a reference point.

The system can be used as an identification system and to obtain a positive identification images from said at least one optical signal means must be from a set or subset of predetermined images.

A time factor can be associated with said set or subset of predetermined images.

The at least one optical signal means can also satisfy a predetermined sequence of images from said set or subset in order for a positive identification to result.

The present invention also provides a gaming system such as a computer based, console based, arcade based gaming system, wherein a system described above in paragraphs [009] to [045] is utilised to provide orientation data to a control system for said gaming system and or an identification mechanism to allow access to said gaming system.

The present invention further provides an optical signal panel for use in an object orientation data collection system and or in an identification system, said optical signal panels including a plurality of optical signal means which independently or in association with each other produce a change in the visible signal emanating from said panel, said signal being adapted to be processed by a signal processing means to identify and or quantify the magnitude and or direction of change in orientation of said panel relative to a sensing means which senses said optical signal.

The panel can include at least two lenticular systems.

The at least two lenticular systems can have their respective columnar orientations being at an angle to each other.

Preferably no two lenticular systems have the same columnar orientation on said panel.

The panel can include one or a combination of more than one of the following visible through said lenticular systems: a pattern; an indicia; a colour; a shape.

The plurality of optical signal means can be such that when a respective one of said plurality of optical signal means is viewed from different angles, then an exhibited a pattern will change to a different pattern; or an exhibited indicia will change to a different indicia; or a exhibited colour will change to a different colour, or an exhibited shape will change to a different shape.

The plurality of optical signal means can be such that when a respective one of said plurality of optical signal means is viewed from different angles, then an exhibited pattern will change to one or more than one of: an indicia, colour or shape; or an exhibited indicia will change to one or more than one of: a pattern, colour, shape; or an exhibited colour will change to one or more than one of: a pattern, indicia, shape; or an exhibited shape will change to one or more than one of: a pattern, indicia, colour.

The plurality of optical signal means can produce a signal which is colour based.

The present invention also provides a game controller or an identification tag or card including a panel as described in any one of paragraphs 47 to 54.

Through out the specification and claims the words “lenticular” and “lenticule”, and words or expressions derived therefrom, have a meaning which includes that the lens elements are not limited to a cylindrical columnar or hemi-cylindrical columnar lens. Unless expressly indicated the lens can include other shape lenses, such a rectangular prism, triangular prisms and can further include semi- or hemi-spherical; toroidal (as in the case of FRESNEL lenses); a matrix or array of a multiplicity of discrete lenses, whether they be concave or convex, or the lenses are square, rectangular, polygonal, pyramidal etc.

### BRIEF DESCRIPTION OF THE DRAWINGS

Embodiments of the present invention will now be described, by way of example only, with reference to the accompanying drawings, in which:

FIG. 1 is schematic representation of a panel of lenticular systems;

FIG. 2 illustrates the possible lenticular images able to be displayed by the lenticular systems of FIG. 1;

FIG. 3 illustrates the panel of FIG. 1 displaying lenticular images which would be viewable when the panel of FIG. 1 is in a plane perpendicular to the direction to a camera;

FIG. 4, being made up of FIGS. 4A, 4B and 4C, illustrates the panel of FIG. 1 in three orientations displaying lenticular images which would be viewable when the panel of FIG. 1 is rotated clockwise and anti-clockwise around a vertical axis from a plane perpendicular to the direction to a camera;

FIG. 5, being made up of FIGS. 5A, 5B and 5C, illustrates the panel of FIG. 1 in three orientations displaying lenticular images which would be viewable when the panel of FIG. 1 is rotated in two directions around a horizontal axis from a plane perpendicular to the direction to a camera;

FIG. 6, being made up of FIGS. 6A, 6B and 6C, illustrates the panel of FIG. 1 in three orientations displaying lenticular images which would be viewable when the panel of FIG. 1 is rotated in two directions around an inclined axis from a plane perpendicular to the direction to a camera;

FIG. 7, being made up of FIGS. 7A, 7B and 7C, illustrates the panel of FIG. 1 in three orientations displaying lenticular images which would be viewable when the panel of FIG. 1 is rotated in two direction around an inclined axis (which is at 90° to the axis of rotation in FIG. 7) from a plane perpendicular to the direction to a camera;

FIG. 8 illustrates the panel of FIG. 1 showing the orientations of FIGS. 4 to 7;

FIG. 9 illustrates schematically the use of the panel of FIG. 1 on a game controller and providing a signal to a digital camera;

FIG. 10 illustrates a panel having a composite of twelve lenticular systems, showing only the orientation of the columnar lenticules in each of the twelve lenticular systems or segments;

FIG. 11 illustrates the shapes or symbols that the panel of FIG. 10 may produce when rotated about the axes of rotation used in FIGS. 4 to 7;

FIG. 12 illustrates the shapes or symbol of FIG. 11, with additional grey colouring where other segments are in a transitional orientation;

FIG. 13 illustrates a flow chart of the steps in the processing of the orientation data produced by the panels;

FIG. 14 illustrates an unambiguously shaped panel or target, similar to the panel of FIG. 1, where three lenticular systems are utilised; and

FIG. 15 illustrates schematically the use of multiple cameras or sensing means to obtain differing images from a lenticular panel.

### DETAILED DESCRIPTION OF THE EMBODIMENT OR EMBODIMENTS

While the following description of a preferred embodiment will be directed to a system useable with a game controller, it will be understood that the invention is equally applicable to other diverse fields such as robotics, vehicular crash testing, materials handling systems and any other system requiring orientation data such as an identification system as described below.

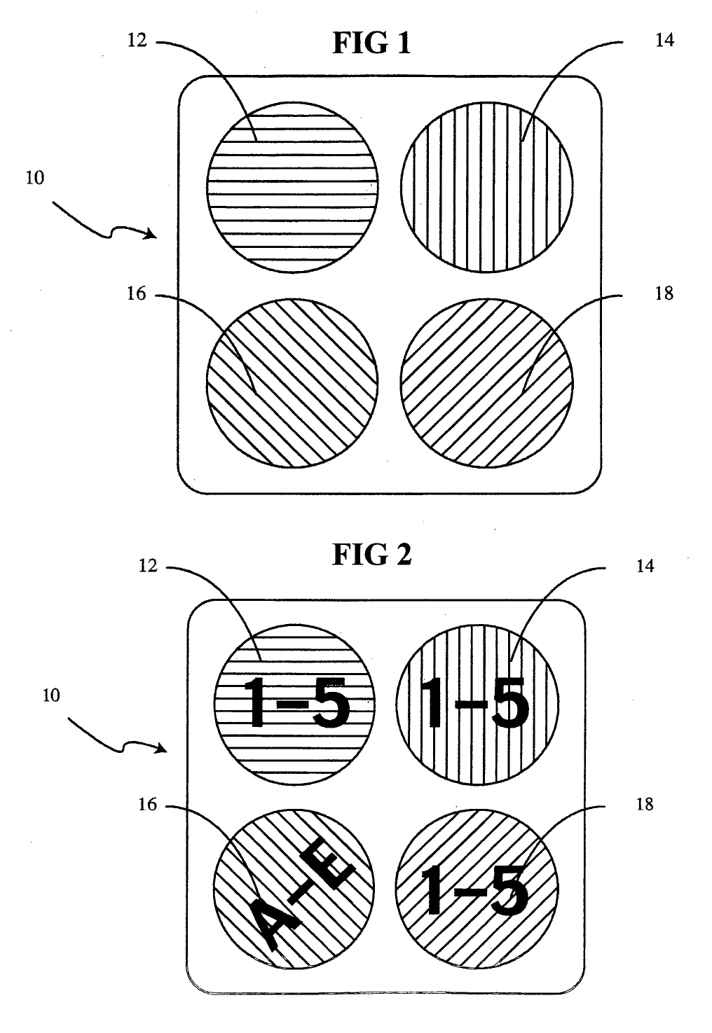

Illustrated in FIG. 1 is a panel 10 having four lenticular systems 12, 14, 16, and 18. Each of the lenticular systems has a screen or layer of columnar lenticules overlying a plurality of lenticular images which form a lenticular image sequence. The number of lenticular images selected will be a function of the angular accuracy desired from the orientation data system. For the sake of explanation, the lenticular image sequence of each lenticular system 12, 14, 16 and 18 will be referred to as each having five lenticular images, with each lenticular image being viewable when the lenticular system is rotated about an axis parallel to the direction of the columnar lenticules. A different image is viewable for every 9.40 of rotation, where the angle of rotation between the start of the first lenticular images and the end of the fifth lenticular images is 47°.

As is illustrated in FIG. 1, the lenticular system 12 is oriented, by means of the direction of the columnar lenticules, at 0° on a Cartesian plane (or East to West, West to East on a compass face), while lenticular system 14 is at 90° on a Cartesian plane (or North to South, South to North on a compass face), lenticular system 16 is oriented at 135° or 315° on a Cartesian plane (North West to South East, South East to North West on a compass face) and finally lenticular system 18 is oriented at 45° or 225° (North East to South West, South West to North East on a compass face).

In FIG. 2, the lenticular systems 12, 14 and 18 are each illustrated as having five distinct images, in this case images of the numerals 1, 2, 3, 4, and 5. Whereas the lenticular system 16 is illustrated as having five distinct images as well, however these images are of the letters A, B, C, D, E. If desired each respective lenticular system can have a different image sequence.

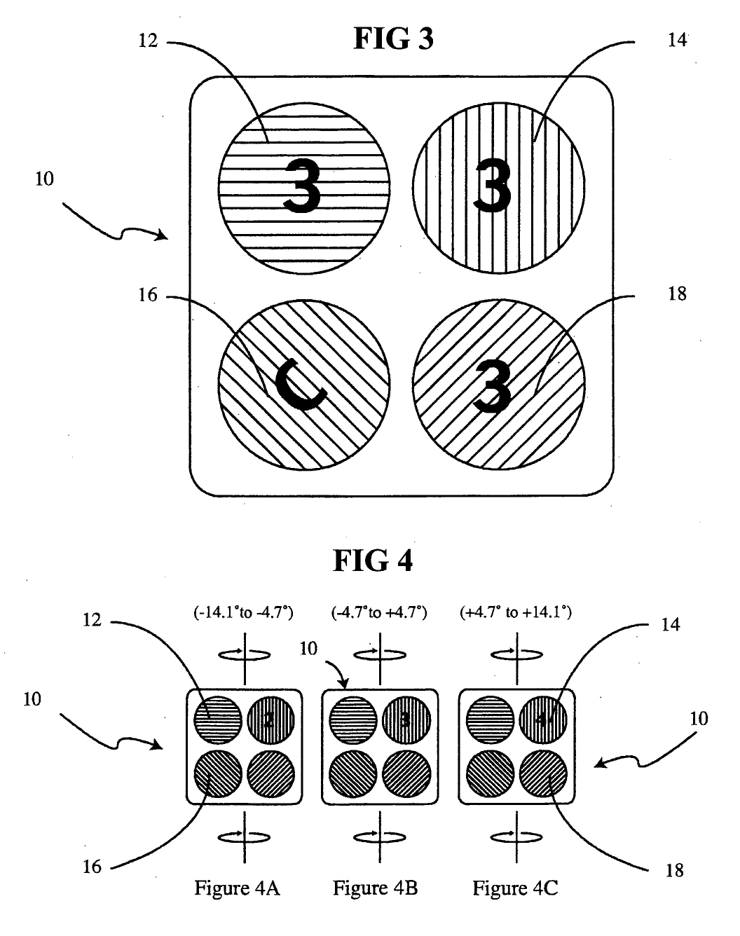

As is illustrated in FIG. 3, the lenticular systems 12, 14, 16 and 18 are designed so that when viewed perpendicular to the eye of a human or the lens of a digital camera, the central lenticular image is visible of each lenticular system's lenticular image sequence. In this case, for the lenticular systems 12, 14 and 18 the numeral 3 is visible, while for the lenticular system 16, the letter C is visible.

As illustrated in FIG. 4, there are three sub-FIGS. 4A, 4B and 4C. Sub-FIG. 4A illustrates the panel 10 theoretically rotated 4.7° around an axis parallel to the direction of lenticular columns of lenticular system 14 whereby the side of the panel 10 with lenticular system 14 is rotated out of the page and the opposite side rotated into the page. As can be seen from sub-FIG. 4A the lenticular system 14 now displays a numeral 2 (and will continue to do so for a further 9.4° of rotation in the same direction), whereas in sub-FIG. 4C, which is rotated 4.7° in the opposite direction from 0°, the numeral 4 is visible (and will continue to do so for a further 9.4° of rotation in the same direction). The central sub-FIG. 4B illustrates the panel 10 at 0° to the viewer, that is where the panel 10 is in a plane perpendicular or normal to a line to the camera or eye or viewer.

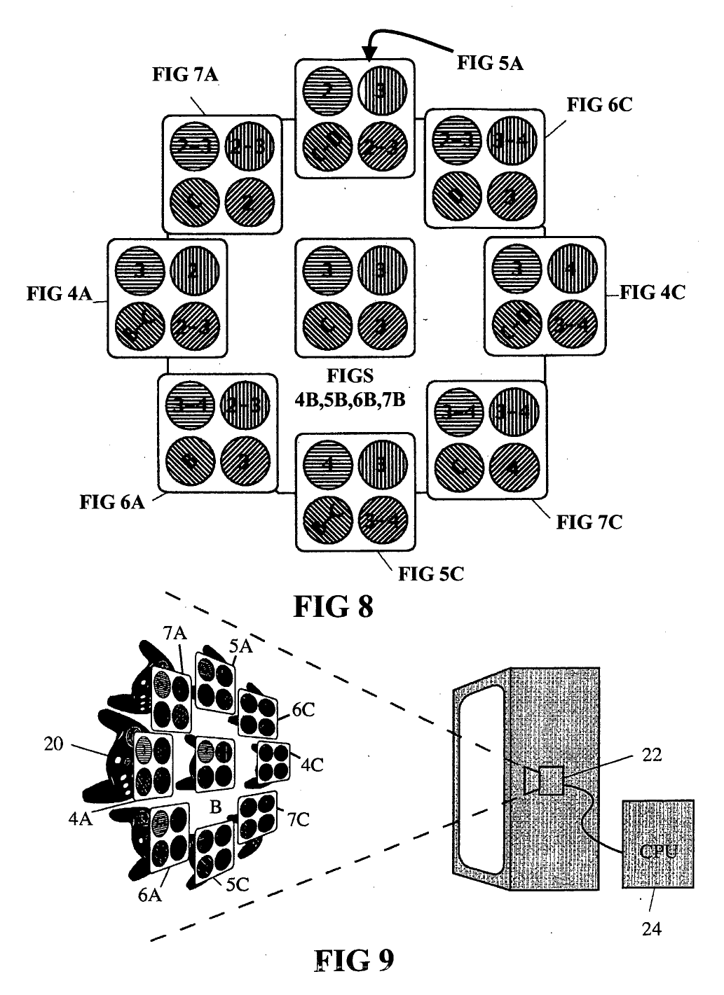

The lenticular systems 16 and 18, due to the angular orientation of the lenticular columns, may have their displayed images changed slightly due to transitional orientation, however, it is expected that the lenticular system 12 will not experience such a transition. These transitional changes or respective lack thereof, is illustrated in FIG. 8 by the sub-FIGS. 4A and 4C.

Rotation of the panel 10 by a further 9.4° in a respective direction will make the numerals 1 and 5 visible on the lenticular system 14 (and will continue to do so for a further 9.4° of rotation in the same direction).

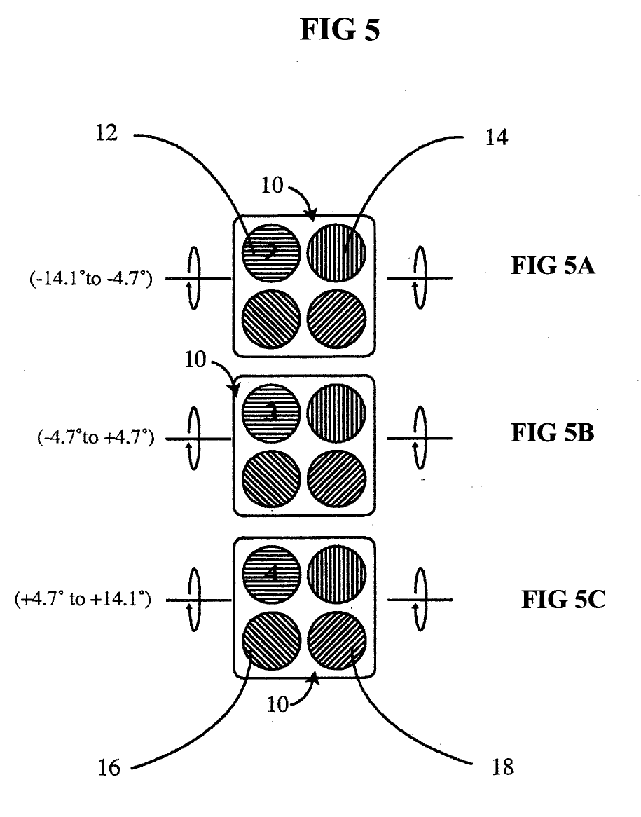

In a similar manner, the lenticular system 12 in the top and bottom representations, being sub-FIGS. 5A and 5C respectively of FIG. 5, and the rest of the lenticular systems 14, 16 and 18, will function in the same way as described in respect of FIG. 4, when the panel 10 is rotated about an axis which is parallel to the direction of the lenticular columns of the lenticular system 12. In this rotational element the lenticular system 16 and 18 are expected to undergo some transitional change to their images, while the lenticular system 14 will not. These transitional changes or respective lack thereof, is illustrated in FIG. 8 by the sub-FIGS. 5A and 5C.

If the panel 10 in sub-FIGS. 5A and 5C were rotated a further 9.4° in a respective direction, then the numerals 1 and 5 respectively will be visible on the lenticular system 12, (and will continue to do so for a further 9.4° of rotation in the same direction).

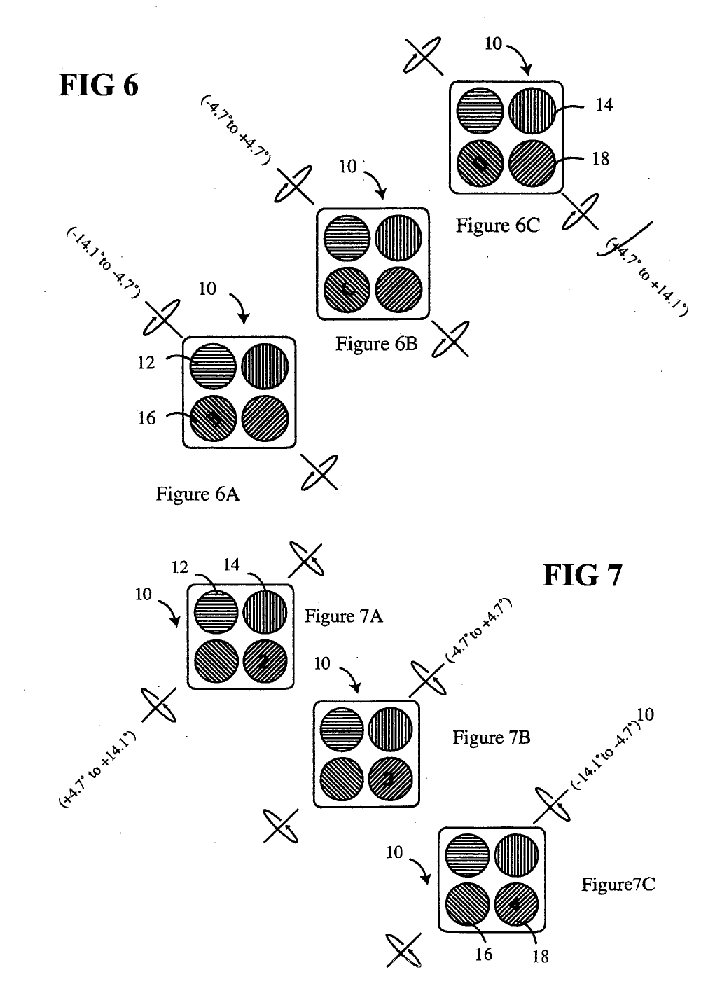

In similar fashion, the lenticular system 16 in the bottom left and top right representations, being sub-FIGS. 6A and 6C respectively of FIG. 6, and the other lenticular systems 12, 14 and 18, will function in much the same way as in FIGS. 4 and 5, when the panel 10 is rotated about an axis which is parallel to the direction of the lenticular columns of the lenticular system 16. In this rotational element the lenticular system 12 and 14 are expected to undergo some transitional change to their images, while the lenticular system 18 will not. These transitional changes or respective lack thereof, is illustrated in FIG. 8 by the sub-FIGS. 6A and 6C.

If the panel 10 in sub-FIGS. 6A and 6C were rotated a further 9.4° in a respective direction, then the letters A and D will be visible on the lenticular system 16 (and will continue to do so for a further 9.4° of rotation in the same direction).

In a similar manner, the lenticular system 18 in the top left and bottom right representations, being sub-FIGS. 7A and 7C respectively of FIG. 7, and the other lenticular systems 12, 14 and 16, will function in much the same way as in FIGS. 4, 5, and 6 when the panel 10 is rotated about an axis which is parallel to the direction of the lenticular columns of the lenticular system 18. In this rotational element the lenticular system 12 and 14 are expected to undergo some transitional change to their images, while the lenticular system 16 will not. These transitional changes or respective lack thereof, is illustrated in FIG. 8 by the sub-FIGS. 7A and 7C.

If the panel 10 in sub-FIGS. 7A and 7C were rotated a further 9.4° in a respective direction, then the numerals 1 and 5 will be visible on the lenticular system 18 (and will continue to do so for a further 9.4° of rotation in the same direction).

As is mentioned above, the transitional changes mentioned in respect of FIGS. 4 to 7 are illustrated in FIG. 8, wherein the rotation images, being the left and right representations (sub-FIGS. 4A and 4C) of FIG. 4, top and bottom representations (sub-FIGS. 5A and 5C) of FIG. 5, bottom left and top right representations (sub-FIGS. 6A and 6C) of FIG. 6; and top left and bottom right representations (sub-FIGS. 7A and 7C) of FIG. 7, are composited in FIG. 8.

It can be seen from the bottom left (sub-FIG. 6A) for example, that the lenticular systems 12 and 14 indicate “3-4” and “2-3” respectively, meaning that the image visible will be a combination of the numerals 3 and 4 and numerals 2 and 3 respectively.

By the array of possible combinations of images being stored in a look up table in a processing unit which will receive a signal of the images displayed from a digital camera, an unambiguous determination of the angle of the panel 10 to the digital camera will be identifiable.

In FIG. 9, the panel 10 of FIG. 1 is attached to a game controller 20, so that a digital camera 22 is able to receive the light reflected from the panel 10, and more particularly from the lenticular systems 12, 14, 16 and 18. By the digital camera seeing, sensing or reading the reflected light, an identification of the current visible signal received from the panel 10 can be made by a CPU 24, and then compared to a look up table or a logical progression of questions applied to the viewed data.

FIG. 9 illustrates diagrammatically the eight angular orientations in the range of approx. 4.7° to 14.1° away from the central perpendicular or 0 degree orientation, about each of four respective axes of rotation.

If desired, a panel 10 in the front of the controller 20 which is meant to face toward the camera 22, as in FIG. 9, can be used in conjunction with a second panel 10 positioned on the controller 20 at a different angle to the panel 10 on the front. By then using a second camera, positioned at the side of the controller 20, a potentially more accurate assessment of the relative angle can be produced, by means of a cross checking system.

Lenticular systems have limits relating to maximal rotation, beyond which limits the image sequence contained therein will repeat. In the case of a columnar (semi- or hemi-cylindrical) lenticular array, repetition occurs at a rotation of approx. 47°. However it is possible to distinguish between the first lenticular image in a lenticular system and a repeat of that first lenticular image, if there are other lenticular systems such as in segments on the same panel surface as the first segment, but at different lenticule column orientations. If a first lenticular system has been rotated 47° (and is thus repeating its image sequence), a second lenticular system which is oriented diagonally or at an angle to the first, will by virtue of its orientation only have been rotated half as much (in the case of a 45° angular displacement of the lenticule columns) around its own axis, and will therefore be only half way through its image sequence. By comparing the two lenticular images displayed by the two lenticular systems, it becomes possible to determine the angular rotation of the first lenticular system around its axis through a range beyond the maximal rotation limit of a single lenticular array.

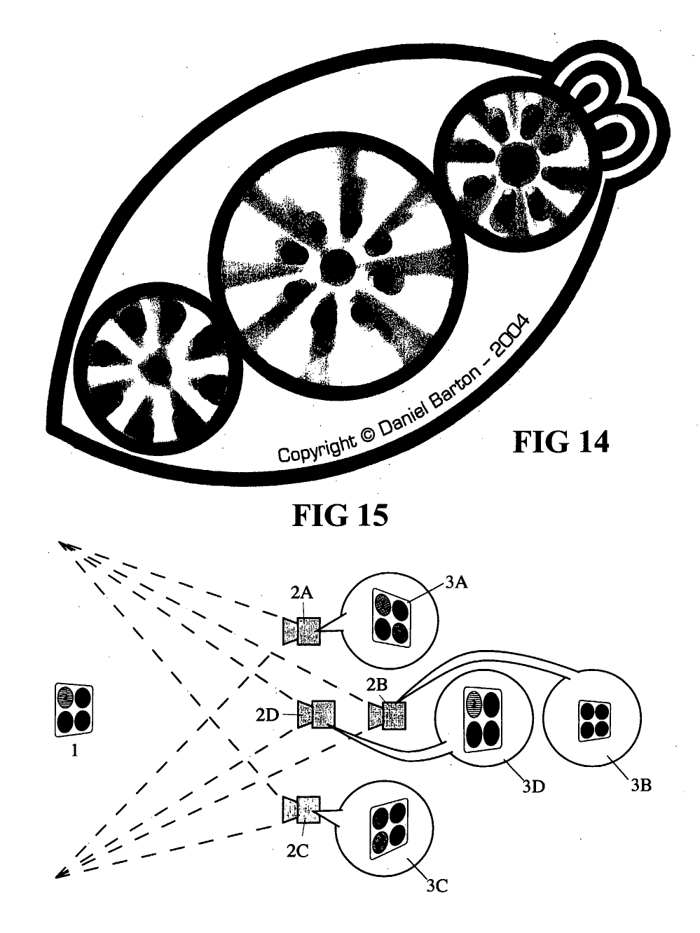

In order for the object tracking software operating on the CPU to more readily identify the panel 10 and the lenticular systems 12, 14, 16 and 18, within the field of view of the camera, the panel 10 can be attached to or incorporated into a target, with a specific, pre-defined and unique shape or design, such as that illustrated in FIG. 14. The object tracking software can then be optimised to detect and track the target and extract the visual information from the panel 10, and the lenticular systems 12 to 18, from the visual data collected by the camera.

The system described above has four lenticular systems 12,14,16 and 18. However a more limited range of angular measurement can be obtained by using a single lenticular system, such as any one of lenticular systems 12, 14, 16 or 18. A greater range of angular measurement can be obtained from two lenticular systems eg 12 & 14, or 16 & 18 etc if they are oriented at angles relative to each other. An even greater range of angular measurement will occur with more lenticular systems.

The system described above in relation to FIGS. 1 to 9, can be made more accurate by providing more lenticular images in the lenticular image sequence, per lenticular system. The more lenticular images used in a lenticular image sequence in a lenticular system, the finer the angular detail that can be displayed. However, it should be noted that the more images that are used in a lenticular system, the more transitional or intermediate blending of consecutive lenticular images will occur. However with appropriate lenticular image design, transitional states can be useful, enabling the extraction of fractional angular data at finer increments than the number of lenticular images and the maximal rotation limit of the particular lenticular array would suggest. Lenticular systems or lenticular display panels can have up to 42 images therein, which will give better angular incrementation.

The above description utilises indicia such as letters and numerals for the lenticular images. However, if desired other systems can be utilised, such as coloured surfaces or colours, shapes, patterns, symbols or indicia, or combinations of these.

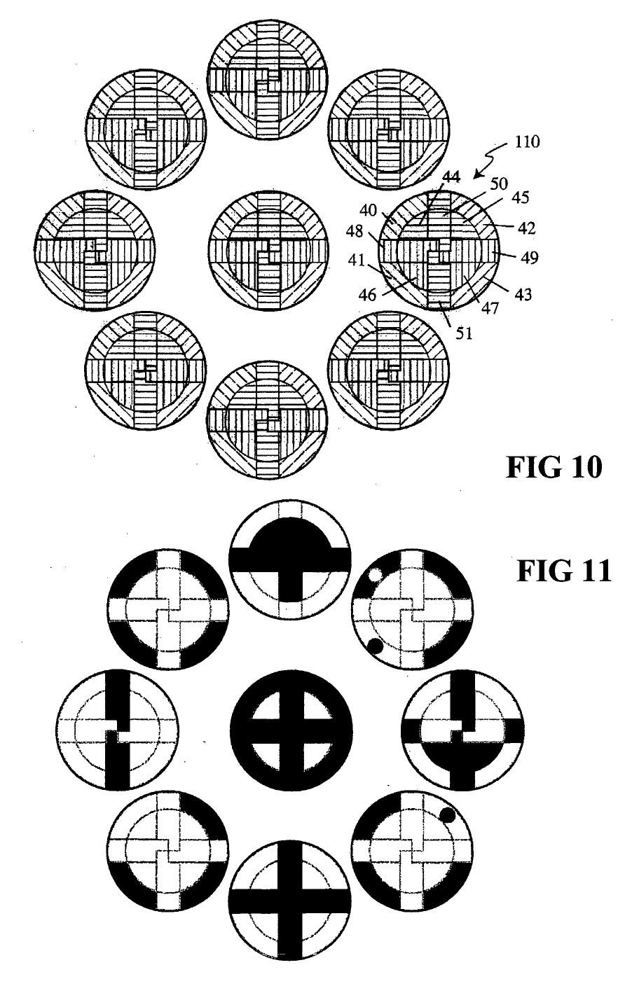

Illustrated in FIG. 10 are nine sub figures all showing a composite panel 110 at 0°. Panel 110 is made up of twelve lenticular systems which form the segments which are composited. The segments are: two left side circumference segments 40 and 41, oriented at the same lenticular column angle; two right side circumference segments 42 and 43 oriented at the same lenticular column angle as each other, but at 90° to the segments 40 and 41; two inner quadrants 44 and 45 being at the same angle but at 45° to both segments 40 and 42; two inner quadrants 46 and 47 being at the same angle but at 90° to quadrants 44 and 45; two horizontal sections 48 and 49 being at the same angle, and two vertical sections 50 and 51, being at the same angle but at 90° to the sections 48 and 49.

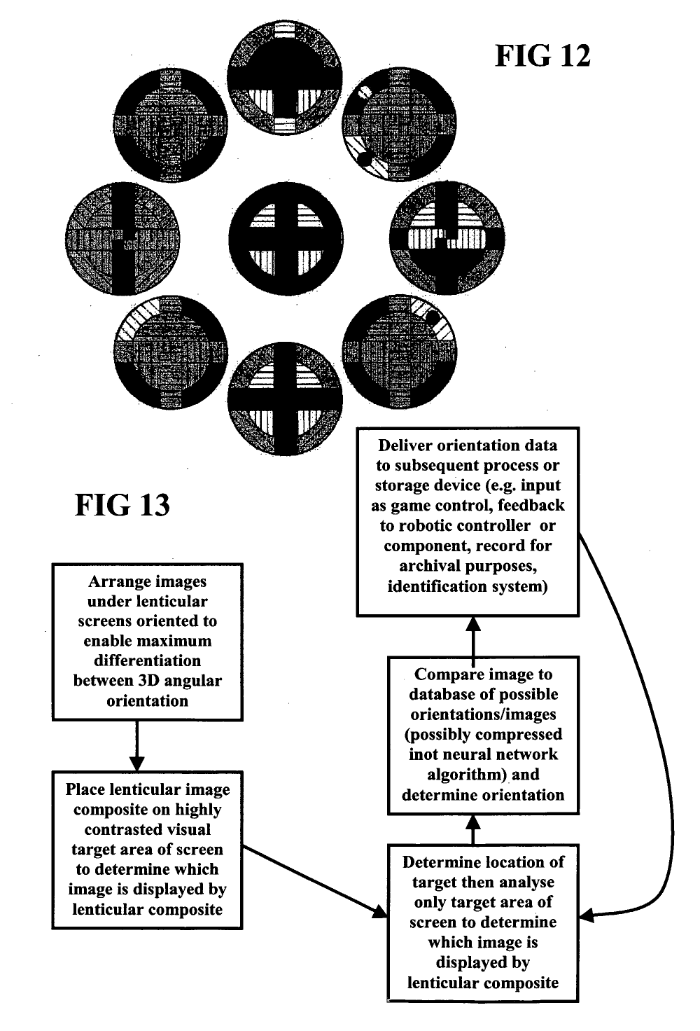

The panel 110 is illustrated in FIG. 11, showing the patterns which would be visible at the angular orientations of FIGS. 4A, 4C, 5A, 5C, 6A, 6C, 7A, and 7C, that is rotated by between 4.7° to 14.1° from the 0° orientation. However, as illustrated in FIG. 12, the same composite panel 110 at the same angular displacements as is illustrated in FIG. 11, attempts to show the transitional images, namely the grey portions.

FIG. 13 is a simplified flow chart of the algorithm used to convert the images detected or sensed into angular orientation data.

While a look up table can be readily used, a logically progressing algorithm could be used instead.

The above description utilises reflected light from one or more lenticular systems on a panel. However, other multi-image systems can be used including holographic images, etched reflective surfaces, other reflective surfaces, images produced by transmission through the panels such as polarising filters, or by light generated from the panels, such as holographic panels.

While the above description has the panels and lenticular systems located on the moving object and the camera stationary, this can be reversed if desired and practical.

In respect of another application of the above described system the lenticular system can be used as a key in an identification system.

In this system a sequence of images is displayed by a lenticular panel when rotated about the X and Y axes is collected via a video camera and analysed by a software system which identifies the sequence. The sequence can then be compared to a pre-existing table or a logically progressing algorithm, and the software system then determines if the sequence is one which should be identified positively or negatively.

The software system can apply different levels of security by applying different rules in the comparison process. For example if the level of security required is low, the software system could merely search for a predetermined set (or subset) of images from a table during a particular identification attempt. If enough of the images which are in the pre-existing table are identified, a positive identification results and access granted, or a negative identification results and access denied, or vica versa.

If higher security is required, the order of the sequence might also be required to be correct. In this case, the lenticular panel would need to be rotated in the X and Y axis in the appropriate order of motions for access to be provided. Security could be even higher by requiring that the correct order of images be displayed within a specific time frame, or individual images or combinations of images could be required to be visible for a predetermined amount of time, before a positive identification is made.

For highest security the software system could also detect how long each individual image within a sequence is displayed during the access attempt. By this means the lenticular system is able to identify a particular three dimensional “gesture” by its sequence and thus accept it as a key.

In operation of this security application, the light sensor, such as a digital camera, digital video camera, could be stationary requiring the lenticular panel or optical signal means to orient or go through a sequence of orientations so as to produce a predetermined sequence of images, patterns, colours, indicia etc.

Alternatively the lenticular panel or optical signal means can be maintained stationary with either the digital camera (or digital video camera) changing its orientation relative to the optical signal means, so as to generate the required predetermined sequence of images to allow for a positive identification. This allows the system to control the angles at which the lenticular panel is viewed.

As a variation of the system mentioned in the previous paragraph, there is illustrated in FIG. 15 a system where there is a camera 2A, 2B, 2C and 2D at one of each of four different rays or orientations from a panel 1, focussed and directed to a location in which to view the lenticular panel 1. In this system the lenticular panel 1 can be held stationary while the four cameras 2A, 2B, 2C and 2D will simultaneously be viewing a separate image. If this image or sequence of images coincides with a look up table or a logical progression algorithm, then positive identification will be made.

If further desired, for a higher security level and or greater complexity, the lenticular panel could be required to change its orientation to generate an predetermined sequence, or each of the cameras can be made to vary their orientation, in which case the sequences resulting therefrom need to match predetermined requirements.

While the identification system could be utilised with gaming systems, it can also be utilised as part of a security system for access to buildings, files, computer terminals etc.

If desired the optical signal means can work on the basis of colour generation. For example, an optical signal which is based on colour differentiation can be generated by means of a variety of colours being located beneath a lenticular panel, whereby light emanating from the lenticular panel will diffuse into a particular colour blend when viewed by the sensing means or the digital camera at a predetermined orientation between them. A multiple number of discs can be arranged onto a panel, with the discs oriented with respect to each other so that they do not have the same colours in the same locations. By this means a different combination of colours will be produced.

The colour system from a plurality of discs could optimally generate a single colour signal, via a diffuser or similar article, from the optical signal means making the task of processing the signal by a CPU a possibly faster processing to obtain an estimation of the change in angular orientation.

The above description describes lenticular systems wherein a single columnar orientation is utilised per each element of a lenticular system. If desired a tessellated array of lenses can be used to display a discrete image per viewing orientation. By the expression tessellated array of lenses it is meant that it is possible to utilise any arrangement of a plurality of lenses such as hexagonal, triangular pyramidal etc. to achieve the desired effect.

It will be understood that the invention disclosed and defined herein extends to all alternative combinations of two or more of the individual features mentioned or evident from the text. All of these different combinations constitute various alternative aspects of the invention.

The foregoing describes embodiments of the present invention and modifications, obvious to those skilled in the art can be made thereto, without departing from the scope of the present invention.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A data collection system having:
(a) at least one sensing means to detect and receive a visible light signal;
(b) an optical characteristic recognition processing means which receives signals from said at least one sensing means;
(c) at least one optical signal means associated with a respective one of said sensing means which generates, reflects or transmits visible light to said sensing means;
wherein said optical signal means causes an optical characteristic to be visible to, or sensed by, said sensing means, said optical characteristic being caused to change when the relative angle between said sensing means and said at least one optical signal means is changed, whereby change in said optical characteristic is processed by said processing means to identify a physical or other characteristic of said at least one optical signal means, and
d) wherein said at least one optical signal means includes at least one of a holographic system, a lenticular system and a polarised filter system.

2. A system as claimed in claim 1, wherein said optical characteristic includes at least one of a pattern; an indicia; a colour; and a shape.

3. A system as claimed in claim 1, wherein said physical or other characteristic of said at least one optical signal means is a change in angle of orientation between said at least one optical signal means and said at least one sensing means.

4. A system as claimed in claim 3, wherein said change in angle of orientation is communicated to a CPU for use in processing to identify or quantify the change in angular orientation between said at least one sensing means and said at least one optical signal means.

5-6. (canceled)

7. A system as claimed in claim 1, wherein said at least one sensing means does not change its orientation or position relative to earth.

8. A system as claimed in claim 1, wherein said at least one optical signal means is positioned on an object the orientation of which is being sensed relative to said at least one sensing means' orientation or position.

9. A system as claimed in claim 1, wherein said at least one optical signal means is at a stationary reference point.

10. A system as claimed in claim 1, wherein said at least one optical signal means does not change its position relative to earth.

11. A system as claimed in claim 1, wherein said at least one sensing means is positioned on an object the orientation of which is being sensed relative to said at least one optical signal means' orientation.

12-13. (canceled)

14. A system as claimed in claim 1, wherein said holographic system, said lenticular system or said polarised filter system each has at least one image associated therewith.

15. (canceled)

16. A system as claimed in claim 1, wherein more than one lenticular system is utilised with respective lenticular images viewable in a respective one of said more than one lenticular system when viewed from different orientations.

17. A system as claimed in claim 16, wherein columnar lenticules are utilised in said lenticular system.

18. A system as claimed in claim 17, wherein multiple lenticular systems are used with the columnar direction of the lenticules of each respective lenticular system being at a different angle to each of the other lenticular systems.

19. A system as claimed in claim 1, wherein said at least one optical signal means is made up of a plurality of lenticular systems, with each lenticular system being located in substantially the same planar orientation.

20. A system as claimed in claim 1, wherein said at least one optical signal means is made up of a plurality of lenticular systems, with one or more lenticular system being located in a different planar orientation to the rest of the lenticular systems.

21. A system as claimed in claim 20, wherein a plurality of lenticular systems are used wherein an angular spacing between columnar lenticules on a first lenticular system relative to one or more other lenticular systems is in the range of 45° to 120°.

22-24. (canceled)

25. A system as claimed in claim 1, wherein said at least one optical signal means is located within a distinctively shaped panel or border to form a target.

26-38. (canceled)

39. A gaming system such as a computer based, console based, arcade based gaming system, wherein a system as claimed in claim 1, is utilised to provide orientation data to at least one of a control system for said gaming system and an identification mechanism to allow access to said gaming system.

40. A optical signal panel for use in at least one of an object orientation data collection system and an identification system, said optical signal panel including a plurality of optical signal means which independently or in association with each other produce a change in a visible signal emanating from said panel, said signal being adapted to be processed by a signal processing means to identify and or quantify at least one of a magnitude and a direction of change in orientation of said panel relative to a sensing means which senses said optical signal, wherein said panel utilises at least one of a holographic system, a lenticular system and a polarized filter system.

41. (canceled)

42. A panel as claimed in claim 40, wherein at least two lenticular systems are utilised having their respective columnar orientations at an angle to each other.

43. A panel as claimed in claim 42, wherein no two lenticular systems have the same columnar orientation on said panel.

44. A panel as claimed in claim 40, wherein said panel includes at least one of the following visible through at least one lenticular system: a pattern; an indicia; a colour; and a shape.

45-48. (canceled)
